(19) United States
(12) Patent Application Publication
(10) Pub. No.: US 2024/0184956 A1
(43) Pub. Date: Jun. 6, 2024

(54) PREDICTION METHOD OF CROWN OF STEEL PLATES AND STRIPS BASED ON DATA DRIVING AND MECHANISM MODEL FUSION

(71) Applicant: Northeastern University, Shenyang City (CN)

(72) Inventors: Xu LI, Shenyang City (CN); Nan CHEN, Shenyang City (CN); Jingguo DING, Shenyang City (CN); Feng LUAN, Shenyang City (CN); Yan WU, Shenyang City (CN); Bingbing MA, Shenyang City (CN); Kun GAO, Shenyang City (CN); Lifeng HUO, Shenyang City (CN); Dianhua ZHANG, Shenyang City (CN)

(21) Appl. No.: 18/014,594

(22) PCT Filed: Jun. 8, 2022
(86) PCT No.: PCT/CN2022/097498

§ 371 Date: Jan. 5, 2023

(30) Foreign Application Priority Data
Jan. 4, 2022 (CN) 202210000389.4

(51) Int. Cl. G06F 30/27; G06F 30/17; G06F 119/08; G06F 119/14

(52) U.S. Cl. CPC G06F 30/27; G06F 30/17; G06F 2119/08; G06F 2119/14

(57) ABSTRACT

The invention belongs to the technical field of quality control of steel plates and strips products, and relates to a prediction method of crown of steel plates and strips based on data driving and mechanism model fusion. By establishing an outlet crown mechanism model of a hot continuous rolling, the mechanism model and a DNN model are combined to establish a DNN model for predicting crown of steel plates and strips, and the calculated value of the mechanism model is taken as a benchmark value of the outlet crown. The deviation amount between the benchmark value and the actual values of the outlet crown is taken as output of the DNN model for predicting crown of the steel plates and strips, and then sum of the predicted value and the benchmark value based on the DNN model for predicting the crown of the steel plates is taken as the final predicted value of the crown of the steel plates and strips.

### BACKGROUND OF THE INVENTION

### 1. Field of the Invention

The invention belongs to the technical field of quality control of steel plates and strips products, and relates to a prediction method of crown of steel plates and strips based on data driving and mechanism model fusion.

### 2. The Prior Arts

Hot rolled strips occupy an important position in the entire industrial system, wherein plate shape is a key indicator to measure whether the quality of hot rolled strips is qualified, and plate shape control has become an important technique in steel plates and strips production. In recent years, a lot of scientific research has been carried out at home and abroad on the rolling process of hot continuous rolling steel plates and strips, such as derivation and establishment of mathematical models. However, the actual rolling process is more complex, and has strong coupling, nonlinear, multi-variable characteristics and other characteristics, and there are uncertain unknown factors, so that it is difficult to establish an accurate mathematical model. Therefore, it is necessary to use an artificial intelligence method based on industrial data drive in combination with a mathematical model to predict the crown of the steel plates and strips and improve prediction precision, so that the site can be controlled more accurately.

In the prediction process of outlet crown of traditional hot continuous rolling, the crown of the steel plates and strips is directly taken as the output value of a neural network. Besides, the benchmark value of the crown of the steel plates and strips is not set, and parameter prediction is performed only by the neural network. The prediction error range is large, and the prediction precision of the model is reduced.

### SUMMARY OF THE INVENTION

In order to solve the technical problems, the invention aims to provide a prediction method of crown of steel plates and strips based on data driving and mechanism model fusion. By establishing a DNN model for predicting crown of steel plates and strips based on data driving and mechanism model fusion, the deviation amount between the calculated value of the mechanism model and the actual values of the outlet crown is taken as the output of the DNN model for predicting crown of steel plates and strips, and the prediction error range can be narrowed.

The invention provides a prediction method of crown of steel plates and strips based on data driving and mechanism model fusion, and the method comprises the following steps:

Step 1: acquiring actual values of an outlet crown, actual measured data related to outlet crown of a hot continuous rolling production line, and calculated data of a process automation level, and using the actual measured data and the calculated data as input data to establish a DNN model for predicting a crown of the steel plates and strips;

Step 2: establishing an outlet crown mechanism model of a hot continuous rolling, performing calculating to obtain the calculated value of the outlet crown of the steel plates and strips as a benchmark value of the outlet crown, and calculating deviation amount of the benchmark value of the outlet crown and the actual values of the outlet crown as output data to establish the DNN model for predicting the crown of the steel plates and strips;

Step 3: randomly dividing modeling data consisting of the input data and the output data into training set data and test set data;

Step 4: based on the training set data, constructing the DNN model for predicting the crown of the steel plates and strips, selecting model parameters, and training the DNN model for predicting the crown of the steel plates and strips;

Step 5: inputting the test set data into the trained DNN model for predicting the crown of the steel plates and strips to predict parameters, and obtaining a predicted value of the deviation amount of the outlet crown;

Step 6: adding up the predicted value of the deviation amount of the outlet crown and the benchmark value of the outlet crown to obtain a final predicted value of the crown, evaluating predicted results by using a mean square error (MSE), a root mean square error (RMSE), a mean absolute error (MAE) of performance indexes and a correlation coefficient R, and analysing a prediction precision.

According to the prediction method of crown of steel plates and strips based on data driving and mechanism model fusion, the Step 1 specially comprises the steps:

Step 1.1: selecting an eight-stand continuous rolling production line for finish rolling, and determining following influencing factors based on a crown mechanism and combined with a hot continuous rolling technology: an outlet width of a rolled piece, an inlet temperature of the rolled piece, an outlet temperature of the rolled piece, a rolling force of stands, a roll-bending force of the stands, a roll wear amount of the stands, an outlet speed of the rolled piece, an outlet thickness of the rolled piece, a thermal expansion of the rolled piece, and a deformation resistance of the rolled piece; and

Step 1.2: according to the influencing factors, extracting the actual measured data and the calculated data of the process automation level from a site, wherein the actual measured data comprises the outlet width of the rolled piece of a finish rolling F8 stand, the inlet temperature of the rolled piece of a finish rolling F1 stand, the outlet temperature of the rolled piece of the finish rolling F8 stand, the rolling force of finish rolling F1-F8 stands, the roll-bending force of the finish rolling F1-F8 stands, the outlet thickness of the rolled piece of the finish rolling F8 stand, the outlet speed of the rolled piece of the finish rolling F1-F8 stands, and the outlet crown of the rolled piece of the finish rolling F8 stand; and the calculated data of the process automation level comprises the deformation resistance of the rolled piece of the finish rolling F1-F8 stands, the outlet thickness of the rolled piece of finish rolling F1-F7 stands, rolling kilometers of the finish rolling F1-F8 stands, and the thermal expansion of the rolled piece during the finish rolling process.

According to the prediction method of crown of steel plates and strips based on data driving and mechanism model fusion, the Step 2 specially comprises the steps:

Step 2.1: establishing an outlet crown mechanism model of the hot continuous rolling, wherein a mathematical equation is as follows:

$$C = \frac{P}{{K}_{P}} + \frac{F}{{K}_{F}} + {E}_{C} {ω}_{C} + {E}_{\sum } ( {ω}_{H} + {ω}_{W} + {ω}_{O} ) + {E}_{0} Δ ; \qquad ( 1 )$$

Wherein C represents the crown of the steel plates and strips; P and F respectively represent a rolling force of stands and a roll-bending force of the stands for enabling roll systems to bend and deform; K_{P} and K_{F} respectively represent a transverse stiffness of a rolling mill and a transverse stiffness of a bending roll; ω_{C} represents a controllable roll crown; ω_{H} represents a hot crown of the rolls caused by a thermal expansion of the rolls; ω_{W} represents a wear crown of the rolls, caused by a wear of the rolls; ω_{O} represents an initial roll crown of the rolls; Δ represents an inlet crown of the steel plates and strips; E₀ represents inlet crown coefficients, E_{C} represents controllable roll crown coefficients, and E_{Σ} represents comprehensive crown coefficients;

Step 2.2: calculating the hot crown of the rolls caused by the thermal expansion of the rolls according to the following equation:

$${ω}_{H} = 2 ( 1 + v ) \frac{{β}_{t}}{R} {{\int }^{R}}_{0} r [ T ( r , z ) - {T}_{0} ( r , z ) ] dr ; \qquad ( 2 )$$

Wherein Bₜ represents thermal expansion coefficients of the rolls and is calculated according to the equation below; v represents a Poisson coefficient of the rolls; T(r,z) represents a temperature at (r,z) where a coordinate is located, r represents a variable along a radius direction of the rolls, and z represents a variable along a length direction of the rolls; T₀(r,z) represents an initial temperature of the rolls; a model is simplified and a temperature of the rolls is regarded as uniform distribution:

$${β}_{t} = \frac{Δ L}{L \times Δ T} ; \qquad ( 3 )$$

Wherein ΔL represents a thermal expansion of the steel plates and strips when the temperature changes by ΔT; L represents a length before expansion;

Step 2.3: calculating a wear amount of the rolls according to the following equation:

$${wear}_{n} = \frac{k \times \sum {P}_{in} \times {l}_{in} ( 1 + α {X}^{4} )}{w} ; \qquad ( 4 )$$

Wherein wearₙ represents the wear amount of the rolls; k represents coefficients related to roll materials and steel plates and strips materials, and Pᵢₙ represents the rolling force of the nₜₕ rolling mill during rolling an iₜₕ steel coil; lᵢₙ represents a length of the iₜₕ steel coil after being rolled by the nₜₕ rolling mill and is calculated according to the equation below; α represents wear coefficients of the rolls; X represents a position of the wear amount; w represents a width of the steel plates and strips:

$${l}_{in} = \frac{{L}_{n} \times {B}_{n} \times {H}_{n}}{{b}_{in} \times {h}_{in}} ; \qquad ( 5 )$$

Wherein lᵢₙ, bᵢₙ and lᵢₙ respectively represent a length, a width and a thickness of the i^{th} steel coil after being rolled by the n^{th} rolling mill, and Lₙ, Bₙ and Hₙ respectively represent a length, a width and a thickness of the steel plates and strips before being rolled;

Step 2.4: calculating the wear crown of the rolls caused by wear of the rolls according to the following equation:

ω_{w}=wearₙ₀−wearₙ₁ (6);

Wherein ω_{w} represents the wear crown of the rolls, wearₙ₀ represents the wear amount of the rolls when a position X of the wear amount is equal to 0, and wearₙ₁ represents the wear amount of the rolls when the position X of the wear amount is equal to ±1;

When X=0, at a center line of the corresponding steel plates and strips:

$${wear}_{n 0} = \frac{k \times \sum {P}_{in} \times {l}_{in}}{w} ; \qquad ( 7 )$$

When X=±1, at an edge of the corresponding steel plates and strips:

$${wear}_{n 1} = \frac{k \times \sum {P}_{in} \times {l}_{in} ( 1 + α )}{w} ; \qquad ( 8 )$$

Step 2.5: taking remaining variables except for the rolling force of the stands, the roll-bending force of the stands, the hot crown of the rolls and the wear crown of the rolls, in the outlet crown mechanism model of the hot continuous rolling, as fixed values, calculating the outlet crown of the steel plates and strips, and taking the outlet crown of the steel plates and strips as the benchmark value of outlet crown.

According to the prediction method of crown of steel plates and strips based on data driving and mechanism model fusion, the Step 4 specially comprises the steps:

Step 4.1: designing a forward propagation algorithm of the DNN model for predicting the crown of the steel plates and strips and determining an activation function according to the equations below:

a¹=x (9),

a^{l}=σ(d^{l})=σ(W^{l}a^{l-1}+b^{l}) (10);

Wherein a¹ represents an output of a first layer, expressed by a matrix method; d represents an output of a lₜₕ layer, expressed by the matrix method, wherein 2≤l≤L, L is a total number of layers of a neural network; W^{l} represents a matrix of the lₜₕ layer and b^{l} represents a bias vector of the lₜₕ layer; x represents an input vector; σ (d) represents the activation function;

The activation function is specifically a Sigmoid activation function:

$$σ ( d ) = \frac{1}{{e}^{- d}} ; \qquad ( 11 )$$

Wherein d is an input of the activation function;

Step 4.2: designing a loss function in a backward propagation algorithm of the DNN model for predicting the crown of the steel plates and strips;

A mean square function is used to measure an output loss of the training set data:

$$J ( W , b , x , y ) = \frac{1}{2} {‖ {a}^{L} - y ‖}_{2}^{2} = \frac{1}{2} {‖ σ ( {W}^{L} \times {a}^{L - 1} + {b}^{L} ) - y ‖}_{2}^{2} ; \qquad ( 12 )$$

Wherein y is a target output of the DNN model for predicting the crown of the steel plates and strips;

Step 4.3: adopting an Adam optimization algorithm and updating and calculating the model parameters to minimize the loss function;

Step 4.4: adopting a Cosine annealing algorithm based on an unequal interval annealing strategy to adjust a learning rate of the DNN model for predicting the crown of the steel plates and strips;

Step 4.5: adopting a variable controlling method to select a number of hidden layers of the network, selecting a number of hidden layer nodes and a number of data groups used during each training, and completing training of the DNN model for predicting the crown of the steel plates and strips.

According to the prediction method of crown of steel plates and strips based on data driving and mechanism model fusion, the number of hidden layers of the constructed DNN model for predicting the crown of the steel plates and strips is 3, the number of hidden layer nodes is 50, and the number of the data groups selected from each training is 128.

According to the prediction method of crown of steel plates and strips based on data driving and mechanism model fusion, the Step 6 specially comprises the steps:

Step 6.1: adding up the predicted value of the deviation amount of the outlet crown and the benchmark value of the outlet crown to obtain the predicted value of the crown of the DNN model for predicting crown of the steel plates and strips;

Step 6.2: directly taking the outlet crown as the output of the DNN model and performing predicting to obtain the predicted value of the crown based on the DNN model;

Step 6.3: performing calculating according to the outlet crown mechanism model of the hot continuous rolling to obtain the calculated value of the outlet crown;

Step 6.4: evaluating the predicted results of the Steps 6.1-6.3 by using the mean square error (MSE), the root mean square error (RMSE), the mean absolute error (MAE) of performance indexes and the correlation coefficient R, and analyzing prediction precision.

According to the prediction method of crown of steel plates and strips based on data driving and mechanism model fusion, in the Step 6.4:

The mean square error (MSE) is calculated according to the following equation:

$$M S E = \frac{1}{n} {\sum }_{j = 1}^{n} {( {y}_{j} - {y}_{j}^{′} )}^{2} ; \qquad ( 13 )$$

The root mean square error (RMSE) is calculated according to the following equation:

$$R M S E = \sqrt{\frac{1}{n} {\sum }_{j = 1}^{n} {( {y}_{j} - {y}_{j}^{′} )}^{2}} ; \qquad ( 14 )$$

The mean absolute error (MAE) of performance indexes is calculated according to the following equation:

$$MAE = \frac{1}{n} {\sum }_{j = 1}^{n} \vert {y}_{j} - {y}_{j}^{′} \vert ; \qquad ( 15 )$$

The correlation coefficient R is calculated according to the following equation:

$$R = \sqrt{1 - \frac{{\sum }_{j = 1}^{n} {( {y}_{j} - {y}_{j}^{′} )}^{2}}{{\sum }_{j = 1}^{n} {( {y}_{j} - \overline{y} )}^{2}}} ; \qquad ( 16 )$$

Wherein yᵢ represents the actual values of the outlet crown, y′ᵢ represents the predicted value obtained through the corresponding model, y̅ represents a mean value of the actual values of the outlet crown, and n represents a total number of data groups in the test set data.

The prediction method of crown of steel plates and strips based on data driving and mechanism model fusion, disclosed by the invention, at least has the following beneficial effects:

According to the method, the variable controlling method is used to determine appropriate parameters of the DNN model for predicting crown of steel plates and strips, and an appropriate optimizer algorithm and a learning rate adjustment algorithm are selected to make the DNN model for predicting crown of steel plates and strips more accurately predict the deviation amount. Then, the deviation amount between the calculated value and the actual values of the mechanism model of crown of the steel plates and strips is taken as the predicted value of the output of the DNN model for predicting crown of steel plates and strips. On one hand, because the introduced benchmark value is close to the actual values in magnitude, the fluctuation range of deviation between the two values is smaller in comparison. Therefore, the deviation between the benchmark value and the actual values is taken as the output of the DNN model for predicting crown of steel plates and strips, which can further narrow the error prediction range, and is closer to the actual value, thereby making the prediction precision of the model higher; and on the other hand, by combining the mechanism model with the DNN model, the whole model can be more consistent with an actual physical process and more persuasive and interpretable. At the present stage, the hot continuous rolling production line is relatively perfect in the collection and storage of industrial data, so that the method disclosed by the invention has strong generalization ability, and a new method is provided to improve the accuracy of outlet crown of the steel plates and strips.

### BRIEF DESCRIPTION OF DRAWINGS

FIG. 1 shows a flow chart of a prediction method of crown of steel plates and strips based on data driving and mechanism model fusion;

FIG. 2 shows an effect chart comparing the predicted value of crown based on a DNN model for predicting crown of steel plates and strips and the predicted value of crown based on the DNN model;

FIG. 3 shows an effect chart comparing the predicted value of the crown based on the DNN model for predicting crown of steel plates and strips and the calculated value of the outlet crown based on the outlet crown mechanism model of hot continuous rolling; and

FIG. 4 shows an effect chart comparing the calculated value of the outlet crown based on the outlet crown mechanism model of hot continuous rolling with the predicted value of the crown based on the DNN model.

### DETAILED DESCRIPTION OF THE PREFERRED EMBODIMENT

The method of the invention will be further described in detail below in combination with the drawings and examples.

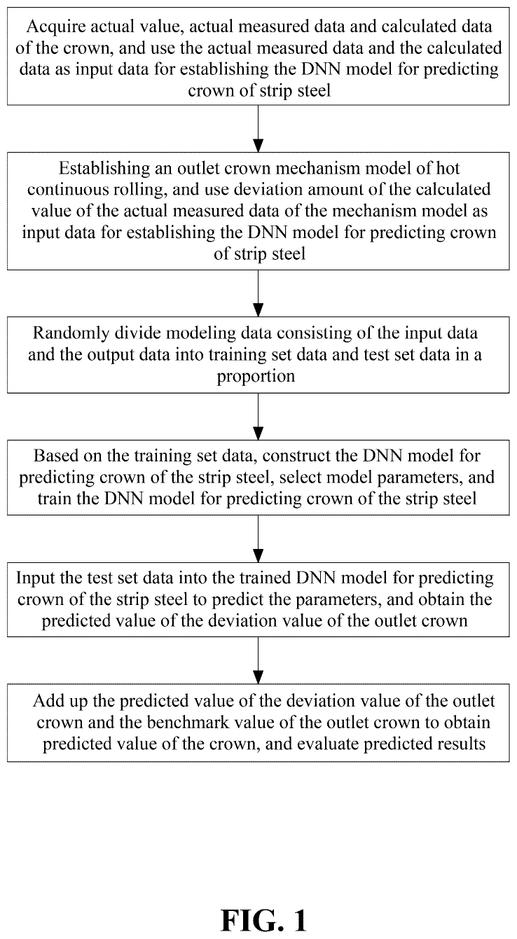

The example is based on a domestic hot continuous rolling production line, and takes the relevant data of the outlet crown of the steel plates and strips as data to establish a model. The overall flow is shown as FIG. 1, and specially comprises the following steps:

Step 1: acquiring actual values of an outlet crown, actual measured data related to outlet crown of a hot continuous rolling production line, and calculated data of a process automation level, and using the actual measured data and the calculated data as input data to establish a DNN model for predicting a crown of steel plates and strips, wherein the Step 1 specially comprises:

Step 1.1: selecting an eight-stand continuous rolling production line for finish rolling, and determining following influencing factors based on a crown mechanism and combined with a hot continuous rolling technology: an outlet width of a rolled piece, an inlet temperature of the rolled piece, an outlet temperature of the rolled piece, a rolling force of stands, a roll-bending force of the stands, a roll wear amount of the stands, an outlet speed of the rolled piece, an outlet thickness of the rolled piece, a thermal expansion of the rolled piece, and a deformation resistance of the rolled piece;

Step 1.2: according to the influencing factors, extracting the actual measured data and the calculated data of the process automation level from a site, wherein the actual measured data comprises the outlet width of the rolled piece of a finish rolling F8 stand, the inlet temperature of the rolled piece of a finish rolling F1 stand, the outlet temperature of the rolled piece of the finish rolling F8 stand, the rolling force of finish rolling F1-F8 stands, the roll-bending force of the finish rolling F1-F8 stands, the outlet thickness of the rolled piece of the finish rolling F8 stand, the outlet speed of the rolled piece of the finish rolling F1-F8 stands, and the outlet crown of the rolled piece of the finish rolling F8 stand; and the calculated data of the process automation level comprises the deformation resistance of the rolled piece of the finish rolling F1-F8 stands, the outlet thickness of the rolled piece of finish rolling F1-F7 stands, rolling kilometers of the finish rolling F1-F8 stands, and the thermal expansion of the rolled piece during the finish rolling process.

A certain roll change cycle is taken as an example, 180 pieces of steel are rolled during the period, and some specific data is shown as Table 1.

TABLE 1
Part specific data in roll change cycle

| | | | roll-bending | | | | | |
|---|---|---|---|---|---|---|---|---|
| | rolling force/kN | | force/kN | | rolling kilometers/m | | | |
| S/N | F1 | F2-F8 | F1 | F2-F8 | F1 | F2-F8 | . . . | crown/mm |
| 1 | 3111.55 | . . . | 190.42 | . . . | 414.556434 | . . . | . . . | 0.021 |
| 2 | 4724.57 | . . . | 189.16 | . . . | 825.3701278 | . . . | . . . | 0.012 |
| 3 | 4666.17 | . . . | 195.45 | . . . | 1238.017136 | . . . | . . . | 0.022 |
| 4 | 5060.44 | . . . | 217.45 | . . . | 1721.493268 | . . . | . . . | 0.014 |
| 5 | 4740 | . . . | 220.7 | . . . | 2203.676473 | . . . | . . . | 0.012 |
| 6 | 4878.29 | . . . | 226.94 | . . . | 2685.907602 | . . . | . . . | 0.007 |
| 7 | 4739.87 | . . . | 228.39 | . . . | 3169.359711 | . . . | . . . | 0.006 |
| 8 | 4745.19 | . . . | 229.42 | . . . | 3651.788625 | . . . | . . . | 0.005 |
| 9 | 5412.33 | . . . | 251.02 | . . . | 4245.185755 | . . . | . . . | 0.013 |
| 10 | 5137.93 | . . . | 253.62 | . . . | 4838.863531 | . . . | . . . | 0.011 |
| 11 | 4994.29 | . . . | 254.02 | . . . | 5432.440532 | . . . | . . . | 0.012 |
| 12 | 4697.31 | . . . | 253.25 | . . . | 6024.171825 | . . . | . . . | 0.01 |
| 13 | 4677.23 | . . . | 249.45 | . . . | 6617.543757 | . . . | . . . | 0.011 |
| 14 | 4633.8 | . . . | 253.44 | . . . | 7210.230985 | . . . | . . . | 0.008 |
| 15 | 4659.15 | . . . | 252.46 | . . . | 7802.127369 | . . . | . . . | 0.006 |
| 16 | 4520 | . . . | 254.83 | . . . | 8394.685041 | . . . | . . . | 0.006 |
| 17 | 4587.33 | . . . | 253.13 | . . . | 8987.026914 | . . . | . . . | 0.011 |
| 18 | 4384.08 | . . . | 252.91 | . . . | 9580.326697 | . . . | . . . | 0.005 |
| 19 | 4564.4 | . . . | 253.12 | . . . | 10172.57511 | . . . | . . . | 0.007 |
| 20 | 4247.43 | . . . | 251.12 | . . . | 10771.9406 | . . . | . . . | 0.01 |
| 21-180 | . . . | . . . | . . . | . . . | . . . | . . . | . . . | . . . |

Step 2: an outlet crown mechanism model of hot continuous rolling is established, calculating is performed to obtain the calculated value of the outlet crown of the steel plates and strips as a benchmark value of the outlet crown, and deviation amount of the benchmark value of the outlet crown and the actual values of the outlet crown is calculated as output data to establish the DNN model for predicting the crown of the steel plates and strips, wherein the Step 2 specially comprises:

Step 2.1: an outlet crown mechanism model of the hot continuous rolling is established, wherein a mathematical equation is as follows:

$$C = \frac{P}{{K}_{P}} + \frac{F}{{K}_{F}} + {E}_{C} {ω}_{C} + {E}_{\sum } ( {ω}_{H} + {ω}_{W} + {ω}_{O} ) + {E}_{0} Δ ; \qquad ( 1 )$$

Wherein C represents the crown of the steel plates and strips; P and F respectively represent a rolling force of stands and a roll-bending force of the stands for enabling roll systems to bend and deform; K_{P} and K_{F} respectively represent a transverse stiffness of a rolling mill and a transverse stiffness of a bending roll; ω_{C} a represents controllable roll crown; ω_{H} represents a hot crown of the rolls caused by a thermal expansion of the rolls; ω_{W} represents a wear crown of the rolls, caused by a wear of the rolls; ω_{O} represents an initial roll crown of the rolls; Δ represents an inlet crown of the steel plates and strips; E₀ represents inlet crown coefficients, E_{C} represents controllable roll crown coefficients, and E_{Σ} represents comprehensive crown coefficients;

Step 2.2: the hot crown of the rolls caused by the thermal expansion of the rolls is calculated according to the following equation:

$${ω}_{H} = 2 ( 1 + v ) \frac{{β}_{t}}{R} {\int }_{0}^{R} r [ T ( r , z ) - {T}_{0} ( r , z ) ] dr ; \qquad ( 2 )$$

Wherein βₜ represents thermal expansion coefficients of the rolls and is calculated according to the equation below; v represents a Poisson coefficient of the rolls; T(r,z) represents a temperature at (r,z) where a coordinate is located, r represents a variable along a radius direction of the rolls, and z represents a variable along a length direction of the rolls; T₀(r,z) represents an initial temperature of the rolls; a model is simplified and a temperature of the rolls is regarded as uniform distribution:

$${β}_{t} = \frac{Δ L}{L \times Δ T} ; \qquad ( 3 )$$

Wherein ΔL represents a thermal expansion of the steel plates and strips when the temperature changes by ΔT; L represents a length before expansion;

Step 2.3: a wear amount of the rolls is calculated according to the following equation:

$${wear}_{n} = \frac{k \times \sum {P}_{in} \times {l}_{in} ( 1 + α {X}^{4} )}{w} ; \qquad ( 4 )$$

Wherein wearₙ represents the wear amount of the rolls; k represents coefficients related to roll materials and steel plates and strips materials, and Pᵢₙ represents the rolling force of the nₜₕ rolling mill during rolling an iₜₕ steel coil; lᵢₙ represents a length of the iₜₕ steel coil after being rolled by the nₜₕ rolling mill and is calculated according to the equation below; X is a position of the wear amount; w represents a width of the steel plates and strips; α represents wear coefficients of the rolls, and is related to the accumulated length of the steel plates and strips (one rolling cycle), rolling force of the stands and the roll materials, and can be manually set in the range of [0.0004-0.0006], in the example, 0.006 is used as the wear coefficients of the rolls, and the value of each roll change cycle is obtained by regression fitting with a least square method:

$${l}_{in} = \frac{{L}_{n} \times {B}_{n} \times {H}_{n}}{{b}_{in} \times {h}_{in}} \qquad ( 5 )$$

Wherein lᵢₙ, bᵢₙ and hᵢₙ respectively represent a length, a width and a thickness of the iₜₕ steel coil after being rolled by the nₜₕ rolling mill, and Lₙ, Bₙ and Hₙ respectively represent a length, a width and a thickness of the steel plates and strips before being rolled;

Step 2.4: the wear crown of the rolls caused by wear of the rolls is calculated according to the following equation:

ω_{w}=wearₙ₀−wear ₙ₁ (6);

Wherein ω_{w} represents the wear crown of the rolls, wearₙ₀ represents the wear amount of the rolls when a position X of the wear amount is equal to 0, and wearₙ₁ represents the wear amount of the rolls when the position X of the wear amount is equal to ±1;

When X=0, at a center line of the corresponding steel plates and strips:

$${wear}_{n 0} = \frac{k \times \sum {P}_{in} \times {l}_{in}}{w} ; \qquad ( 7 )$$

When X=±1, at an edge of the corresponding steel plates and strips:

$${wear}_{n 1} = \frac{k \times \sum {P}_{in} \times {l}_{in} ( 1 + α )}{w} ; \qquad ( 8 )$$

Step 2.5: remaining variables except for the rolling force of the stands, the roll-bending force of the stands, the hot crown of the rolls and the wear crown of the rolls, in the outlet crown mechanism model of the hot continuous rolling, are taken as fixed values, the outlet crown of the steel plates and strips is calculated, and the outlet crown of the steel plates and strips is taken as the benchmark value of outlet crown.

In the specific implementation, since the crown is greatly affected by the rolling force P of the stands, the roll-bending force F of the stands, thermal deformation of the rolls and the wear deformation of the rolls, but least affected by the remaining variables, the remaining variables are approximately regarded as the fixed values; and hot crown and wear crown of the rolls are obtained through calculation, the rolling force of the stands and the roll-bending force of the stands are extracted from the actual rolling in site, then the crown model is simplified, the calculated value of outlet crown of the steel plates and strips is calculated and the calculated value is taken as the benchmark value of outlet crown.

Step 3: modeling data consisting of the input data and the output data is randomly divided into training set data and test set data in a certain proportion, wherein in the example, the modeling data is divided into training set data and test set data in a ratio of 7:3. If the roll change cycle is taken as an example, 180 groups exist, including 126 groups of the training set data and 54 groups of the test set data.

Step 4: based on the training set data, the DNN model for predicting the crown of the steel plates and strips is constructed, model parameters are selected, and the DNN model for predicting the crown of the steel plates and strips is trained, wherein the Step 4 specially comprises:

Step 4.1: a forward propagation algorithm of the DNN model for predicting the crown of steel plates and strips is designed and an activation function is determined according to the equations below:

a¹=x (9),

a^{l}=σ(d^{l})=σ(W^{l}a^{l-1}+b^{l}) (10);

Wherein a¹ represents an output of a first layer, expressed by a matrix method; d represents an output of a lₜₕ layer, expressed by the matrix method, wherein 2≤l≤L, L is a total number of layers of a neural network; W^{l} represents a matrix of the lₜₕ layer and b^{l} represents a bias vector of the lₜₕ layer; x represents an input vector; σ(d) represents the activation function;

The activation function is specifically a Sigmoid activation function:

$$σ ( d ) = \frac{1}{{e}^{- d}} ; \qquad ( 11 )$$

Wherein d is an input of the activation function;

Step 4.2: a loss function in a backward propagation algorithm of the DNN model for predicting the crown of the steel plates and strips is designed:

Wherein in order to select appropriate parameters to make the output calculated from all training data inputs be equal to or closer to the actual values as much as possible, it is necessary to select the appropriate loss function to measure the output loss of training samples, further update W and b until stop iteration threshold is reached, and output a linear relationship coefficient matrix W and a bias vector b of the hidden layers and the output layers.

In the embodiment, the mean square function is used to measure an output loss of the training set data:

$$J ( W , b , x , y ) = \frac{1}{2} {‖ {a}^{L} - y ‖}_{2}^{2} = \frac{1}{2} {‖ σ ( {W}^{L} \times {a}^{L - 1} + {b}^{L} ) - y ‖}_{2}^{2} ; \qquad ( 12 )$$

Wherein y is a target output of the DNN model for predicting the crown of the steel plates and strips;

Step 4.3: the optimizer algorithm selected for the model is determined, in this way, network parameters affecting model training and model output are updated and calculated to approximate or reach the optimal value so that the loss function is minimized or maximized; and in the example, an Adam optimization algorithm is adopted, and model parameters are updated and calculated, so that the loss function is minimized.

Step 4.4: the selected learning rate adjustment algorithm and related parameters thereof are determined to prevent the condition that due to excessive learning rate, the network fails to converge, wanders around the optimal value and fails to reach the position of the optimal value, and also prevent the condition that due to too low learning rate, the network converges very slowly, the optimization time is greatly prolonged, the network converges easily as soon as entering the local extreme value point, and the optimal solution is not really found. In the embodiment, the Cosine annealing algorithm based on an unequal interval annealing strategy is adopted to adjust the learning rate of the DNN model for predicting crown of steel plates and strips.

Step 4.5: a parameter selection method lies in that the variable controlling method is used to select a number of corresponding hidden layers of the network according to the different effects of the number of different hidden layers on generalization performance, and then the appropriate number of hidden layer nodes is selected according to different errors generated by the number of different hidden layer nodes; similarly, the most appropriate number of training data groups is selected according to the influence of the number of different data groups selected from each training on the degree and speed of model optimization, training of the DNN model for predicting crown of steel plates and strips is completed. The number of hidden layers of the constructed DNN model for predicting the crown of steel plates and strips is 3, the number of hidden layer nodes is 50, and the number of the training data groups selected from each training is 128.

Step 5: the test set data is input into the trained DNN model for predicting the crown of the steel plates and strips to predict parameters, and a predicted value of the deviation amount of the outlet crown is obtained.

Step 6: the predicted value of the deviation amount of the outlet crown and the benchmark value of the outlet crown are added up to obtain a final predicted value of the crown, predicted results are evaluated by using a mean square error (MSE), a root mean square error (RMSE), a mean absolute error (MAE) of performance indexes and a correlation coefficient R, and a prediction precision is analyzed, wherein the Step 6 specially comprises:

Step 6.1: adding up the predicted value of the deviation amount of the outlet crown and the benchmark value of the outlet crown to obtain the predicted value of the crown of the DNN model for predicting crown of steel plates and strips;

Step 6.2: directly taking the outlet crown as the output of the DNN model and performing predicting to obtain the predicted value of the crown based on the DNN model;

Step 6.3: performing calculating according to the outlet crown mechanism model of the hot continuous rolling to obtain the calculated value of the outlet crown; and

Step 6.4: evaluating the predicted results of the Steps 6.1-6.3 by using the mean square error (MSE), the root mean square error (RMSE), the mean absolute error (MAE) of performance indexes and the correlation coefficient R, and analyzing prediction precision.

During the implementation, the mean square error (MSE) is calculated according to the following equation:

$$M S E = \frac{1}{n} {\sum }_{j = 1}^{n} {( {y}_{j} - {y}_{j}^{′} )}^{2} ; \qquad ( 13 )$$

The root mean square error (RMSE) is calculated according to the following equation:

$$R M S E = \sqrt{\frac{1}{n} {\sum }_{j = 1}^{n} {( {y}_{j} - {y}_{j}^{′} )}^{2}} ; \qquad ( 14 )$$

The mean absolute error (MAE) of performance indexes is calculated according to the following equation:

$$MAE = \frac{1}{n} {\sum }_{j = 1}^{n} \vert {y}_{j} - {y}_{j}^{′} \vert ; \qquad ( 15 )$$

The correlation coefficient R is calculated according to the following equation:

$$R = \sqrt{1 - \frac{{\sum }_{j = 1}^{n} {( {y}_{j} - {y}_{j}^{′} )}^{2}}{{\sum }_{j = 1}^{n} {( {y}_{j} - \overline{y} )}^{2}}} ; \qquad ( 16 )$$

Wherein yᵢ represents the actual values of the outlet crown, y′ᵢ represents the predicted value obtained through the corresponding model, y̅ represents a mean value of the actual values of the outlet crown, and n represents a total number of data groups in the test set data.

The predicted results are shown as Table 2.

TABLE 2

| predicted | | | | | | | |
|---|---|---|---|---|---|---|---|
| parameter | model type | result type | MSE | RMSE | MAE | SMAPE | R |
| outlet | application | (deviation + | 9.81E−6 | 0.0062 | 0.0047 | 53.25% | 0.9002 |
| crown | model | benchmark | | | | | |
| | | value) | | | | | |
| | | predicted value | | | | | |
| | DNN | predicted value | 3.59E−4 | 0.0189 | 0.0150 | 71.19% | 0.8730 |
| | model | of crown | | | | | |
| | mechanism | calculated value | 5.51E−5 | 0.0074 | 0.0057 | 68.25% | 0.9091 |
| | model | of crown | | | | | |

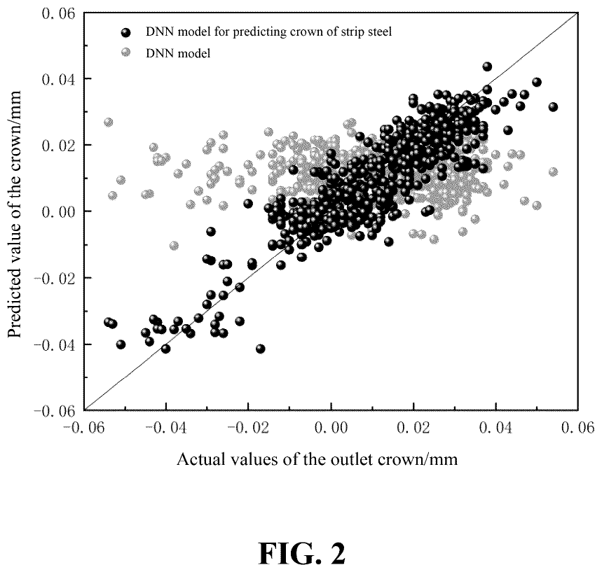

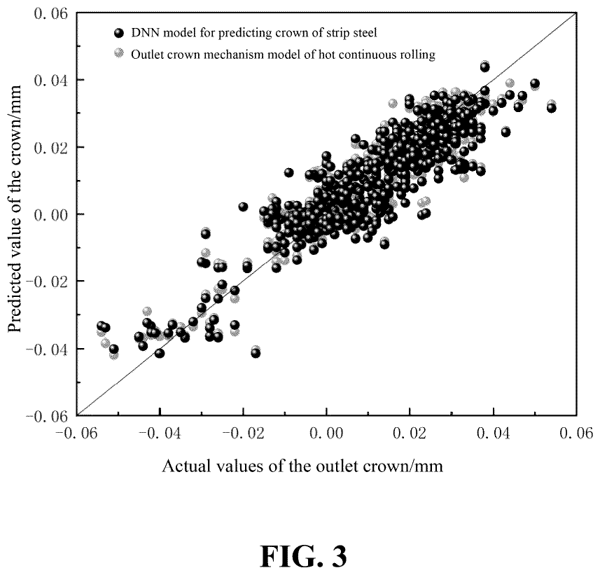

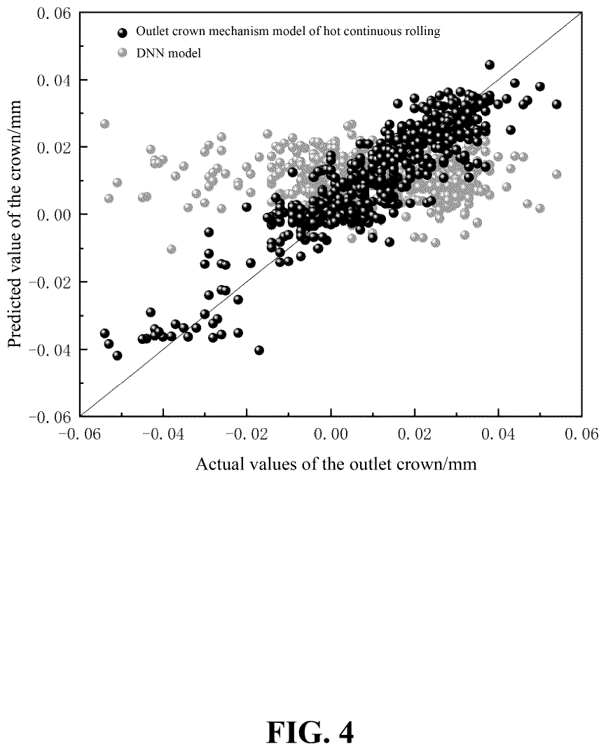

See FIGS. 2-4 for comparison of predicted effects. FIG. 2 shows an effect chart comparing the predicted value of crown based on a DNN model for predicting crown of steel plates and strips and the predicted value of crown based on the DNN model; FIG. 3 shows an effect chart comparing the predicted value of the crown based on the DNN model for predicting crown of steel plates and strips and the calculated value of the outlet crown based on the outlet crown mechanism model of hot continuous rolling; FIG. 4 shows an effect chart comparing the calculated value of the outlet crown based on the outlet crown mechanism model of hot continuous rolling with the predicted value of the crown based on the DNN model.

It can be seen from FIGS. 2-4 that data points are clearly and regularly distributed. Data distribution of the DNN model for predicting crown of steel plates and strips combined with the mechanism model and the DNN model of the invention is more consistent with a straight line y=x in the figs., that is, the predicted value is closer to the actual values. The DNN model for predicting crown of steel plates and strips of the invention has the best performance, and the values of MSE, MAE and RMSE are significantly reduced, which are 9.81E-6, 0.0047 and 0.0062 respectively.

The above is only preferred embodiments of the invention, and does not limit the idea of the invention. Any modification, equivalent replacement, improvement, and the like made within the spirit and principle of the invention shall be included in the protection scope of the invention.

What is claimed is:

1. A prediction method of crown of steel plates and strips based on data driving and mechanism model fusion, comprising the following steps:
Step 1: acquiring actual values of an outlet crown, actual measured data related to the outlet crown of a hot continuous rolling production line and calculated data of a process automation level, and using the actual measured data and the calculated data as input data to establish a DNN model for predicting a crown of steel plates and strips;
Step 2: establishing an outlet crown mechanism model of a hot continuous rolling, performing calculating to obtain a calculated value of the outlet crown of the steel plates and strips as a benchmark value of the outlet crown, and calculating a deviation amount of the benchmark value of the outlet crown and the actual values of the outlet crown as output data to establish the DNN model for predicting the crown of the steel plates and strips;
Step 3: randomly dividing modeling data consisting of the input data and the output data into training set data and test set data;
Step 4: based on the training set data, constructing the DNN model for predicting the crown of the steel plates and strips, selecting model parameters, and training the DNN model for predicting the crown of the steel plates and strips;
Step 5: inputting the test set data into the trained DNN model for predicting the crown of the steel plates and strips to predict parameters, and obtaining a predicted value of the deviation amount of the outlet crown; and
Step 6: adding up the predicted value of the deviation amount of the outlet crown and the benchmark value of the outlet crown to obtain a final predicted value of the crown, evaluating predicted results by using a mean square error (MSE), a root mean square error (RMSE), a mean absolute error (MAE) of performance indexes and a correlation coefficient R, and analyzing a prediction precision.

2. The prediction method of claim 1, wherein the Step 1 further comprises the steps of:
Step 1.1: selecting an eight-stand continuous rolling production line for finish rolling, and determining following influencing factors based on a crown mechanism and combined with a hot continuous rolling technology: an outlet width of a rolled piece, an inlet temperature of the rolled piece, an outlet temperature of the rolled piece, a rolling force of stands, a roll-bending force of the stands, a roll wear amount of the stands, an outlet speed of the rolled piece, an outlet thickness of the rolled piece, a thermal expansion of the rolled piece, and a deformation resistance of the rolled piece; and
Step 1.2: according to the influencing factors, extracting the actual measured data and the calculated data of the process automation level from a site, wherein the actual measured data comprises the outlet width of the rolled piece of a finish rolling F8 stand, the inlet temperature of the rolled piece of a finish rolling F1 stand, the outlet temperature of the rolled piece of the finish rolling F8 stand, the rolling force of finish rolling F1-F8 stands, the roll-bending force of the finish rolling F1-F8 stands, the outlet thickness of the rolled piece of the finish rolling F8 stand, the outlet speed of the rolled piece of the finish rolling F1-F8 stands, and the outlet crown of the rolled piece of the finish rolling F8 stand; and the calculated data of the process automation level comprises the deformation resistance of the rolled piece of the finish rolling F1-F8 stands, the outlet thickness of the rolled piece of finish rolling F1-F7 stands, rolling kilometers of the finish rolling F1-F8 stands, and the thermal expansion of the rolled piece during the finish rolling process.

3. The prediction method of claim 1, wherein the Step 2 further comprises the steps of:
Step 2.1: establishing the outlet crown mechanism model of the hot continuous rolling, wherein a mathematical equation is as follows:
$$C = \frac{P}{{K}_{P}} + \frac{F}{{K}_{F}} + {E}_{C} {ω}_{C} + {E}_{\sum } ( {ω}_{H} + {ω}_{W} + {ω}_{O} ) + {E}_{0} Δ ; \qquad ( 1 )$$
wherein, C represents the crown of the steel plates and strips; P and F respectively represent a rolling force of stands and a roll-bending force of the stands for enabling roll systems to bend and deform; K_{P} and K_{F} respectively represent the a transverse stiffness of a rolling mill and a transverse stiffness of a bending roll; ω_{C} represents a controllable roll crown; ω_{H} represents a hot crown of the rolls caused by a thermal expansion of the rolls; ω_{W} represents a wear crown of the rolls, caused by a wear of the rolls; ω_{O} represents an initial roll crown of the rolls; Δ represents an inlet crown of the steel plates and strips; E₀ represents inlet crown coefficients, E_{C} represents controllable roll crown coefficients, and E_{Σ} represents comprehensive crown coefficients;
Step 2.2: calculating the hot crown of the rolls caused by the thermal expansion of the rolls according to the following equation:
$${ω}_{H} = 2 ( 1 + v ) \frac{{β}_{t}}{R} {\int }_{0}^{R} r [ T ( r , z ) - {T}_{0} ( r , z ) ] dr ; \qquad ( 2 )$$
wherein Bₜ represents thermal expansion coefficients of the rolls and is calculated according to the equation below; v represents a Poisson coefficient of the rolls; T(r,z) represents a temperature at (r,z) where a coordinate is located, r represents a variable along a radius direction of the rolls, and z represents a variable along a length direction of the rolls; T₀(r,z) represents an initial temperature of the rolls; a model is simplified and a temperature of the rolls is regarded as uniform distribution:
$${β}_{t} = \frac{Δ L}{L \times Δ T} ; \qquad ( 3 )$$
wherein ΔL represents a thermal expansion of the steel plates and strips when the temperature changes by ΔT; L represents a length before expansion;
Step 2.3: calculating a wear amount of the rolls according to the following equation:
$${wear}_{n} = \frac{k \times \sum {P}_{in} \times {l}_{in} ( 1 + α {X}^{4} )}{w} ; \qquad ( 4 )$$
wherein wearₙ represents the wear amount of the rolls; k represents coefficients related to roll materials and steel plates and strips materials, and Pᵢₙ represents the rolling force of the nₜₕ rolling mill during rolling an iₜₕ steel coil; lᵢₙ represents a length of the i^{th} steel coil after being rolled by the n^{th} rolling mill and is calculated according to the equation below; α represents wear coefficients of the rolls; X represents a position of the wear amount; W represents a width of the steel plates and strips:
$${l}_{in} = \frac{{L}_{n} \times {B}_{n} \times {H}_{n}}{{b}_{in} \times {h}_{in}} ; \qquad ( 5 )$$
wherein lᵢₙ, bᵢₙ and hᵢₙ respectively represent a length, a width and a thickness of the i^{th} steel coil after being rolled by the nih rolling mill, and Lₙ, Bₙ and Hₙ respectively represent a length, a width and a thickness of the steel plates and strips before being rolled;
Step 2.4: calculating the wear crown of rolls caused by wear of the rolls according to the following equation:
ω_{w}=wearₙ₀−wearₙ₁ (6);
wherein ω_{w} represents the wear crown of the rolls, wearₙ₀ represents the wear amount of the rolls when a position X of the wear amount is equal to 0, and wearₙ₁ represents the wear amount of the rolls when the position X of the wear amount is equal to ±1;
when X=0, at a center line of the corresponding steel plates and strips:
$${wear}_{n 0} = \frac{k \times \sum {P}_{in} \times {l}_{in}}{w} ; \qquad ( 7 )$$
when X=±1, at an edge of the corresponding steel plates and strips:
$${wear}_{n 1} = \frac{k \times \sum {P}_{in} \times {l}_{in} ( 1 + α )}{w} ; \qquad ( 8 )$$
Step 2.5: taking remaining variables except for the rolling force of the stands, the roll-bending force of the stands, the hot crown of the rolls and the wear crown of the rolls, in the outlet crown mechanism model of the hot continuous rolling, as fixed values, calculating the outlet crown of the steel plates and strips, and taking the outlet crown of the steel plates and strips as the benchmark value of the outlet crown.

4. The prediction method of claim 1, wherein the Step 4 further comprises the steps of:
Step 4.1: designing a forward propagation algorithm of the DNN model for predicting the crown of the steel plates and strips and determining an activation function according to the equations below:
a¹=x (9),
a^{l}=σ(d^{l})=σ(W^{l}a^{l-1}30 b^{l}) (10);
wherein a¹ represents an output of a first layer, expressed by a matrix method; d represents an output of a l^{th} layer, expressed by the matrix method, wherein 2≤l≤L, L is a total number of layers of a neural network; W^{l} represents a matrix of the lₜₕ layer and b^{l} represents a bias vector of the lₜₕ layer; x represents an input vector; σ(d) represents the activation function;
the activation function is specifically a Sigmoid activation function:
$$σ ( d ) = \frac{1}{{e}^{- d}} ; \qquad ( 11 )$$
wherein d is an input of the activation function;
Step 4.2: designing a loss function in a backward propagation algorithm of the DNN model for predicting the crown of the steel plates and strips:
a mean square function is used to measure an output loss of the training set data:
$$J ( W , b , x , y ) = \frac{1}{2} {‖ {a}^{L} - y ‖}_{2}^{2} = \frac{1}{2} {‖ σ ( {W}^{L} \times {a}^{L - 1} + {b}^{L} ) - y ‖}_{2}^{2} ; \qquad ( 12 )$$
wherein y is a target output of the DNN model for predicting the crown of the steel plates and strips;
Step 4.3: adopting an Adam optimization algorithm and updating and calculating the model parameters to minimize the loss function;
Step 4.4: adopting a Cosine annealing algorithm based on an unequal interval annealing strategy to adjust a learning rate of the DNN model for predicting the crown of the steel plates and strips; and
Step 4.5: adopting a variable controlling method to select a number of hidden layers of the network, selecting a number of hidden layer nodes and a number of data groups used during each training, and completing training of the DNN model for predicting the crown of the steel plates and strips.

5. The prediction method of claim 4, wherein the number of the hidden layers of the constructed DNN model for predicting the crown of the steel plates and strips is 3, the number of the hidden layer nodes is 50, and the number of the data groups selected from each training is 128.

6. The prediction method of claim 1, wherein the Step 6 further comprises the steps of:
Step 6.1: adding up the predicted value of the deviation amount of the outlet crown and the benchmark value of the outlet crown to obtain the predicted value of the crown of the DNN model for predicting crown of the steel plates and strips;
Step 6.2: directly taking the outlet crown as the output of the DNN model and performing predicting to obtain the predicted value of the crown based on the DNN model;
Step 6.3: performing calculating according to the outlet crown mechanism model of the hot continuous rolling to obtain the calculated value of the outlet crown; and
Step 6.4: evaluating the predicted results of the Steps 6.1-6.3 by using the mean square error (MSE), the root mean square error (RMSE), the mean absolute error (MAE) of performance indexes and the correlation coefficient R, and analyzing the prediction precision.

7. The prediction method of claim 6, wherein in the Step 6.4:
the mean square error (MSE) is calculated according to the following equation:
$$MSE = \frac{1}{n} {\sum }_{j = 1}^{n} {( {y}_{j} - {y}_{j}^{′} )}^{2} ; \qquad ( 13 )$$
the root mean square error (RMSE) is calculated according to the following equation:
$$RMSE = \sqrt{\frac{1}{n} {\sum }_{j = 1}^{n} {( {y}_{j} - {y}_{j}^{′} )}^{2}} ; \qquad ( 14 )$$
the mean absolute error (MAE) of performance indexes is calculated according to the following equation:
$$MAE = \frac{1}{n} {\sum }_{j = 1}^{n} \vert {y}_{j} - {y}_{j}^{′} \vert ; \qquad ( 15 )$$
the correlation coefficient R is calculated according to the following equation:
$$R = \sqrt{1 - \frac{{\sum }_{j = 1}^{n} {( {y}_{j} - {y}_{j}^{′} )}^{2}}{{\sum }_{j = 1}^{n} {( {y}_{j} - \overline{y} )}^{2}}} ; \qquad ( 16 )$$
wherein yᵢ represents the actual values of the outlet crown, y′ᵢ represents the predicted value obtained through the corresponding model, y̅ represents a mean value of the actual values of the outlet crown, and n represents a total number of data groups in the test set data.
